(19) United States
(12) Patent Application Publication
(10) Pub. No.: US 2025/0073667 A1
(43) Pub. Date: Mar. 6, 2025

(54) COMPLEX IONIC COMPOUND, ITS PREPARATION METHOD, AND ITS USE IN RECOVERY OF METAL IONS

(71) Applicant: NAN YA PLASTICS CORPORATION, TAIPEI (TW)

(72) Inventors: Te-Chao Liao, TAIPEI (TW); Wei-Sheng Cheng, TAIPEI (TW); Chia-Shan Chang, TAIPEI (TW); Yu-lin Li, TAIPEI (TW)

(73) Assignee: NAN YA PLASTICS CORPORATION, TAIPEI (TW)

(21) Appl. No.: 18/491,799

(22) Filed: Oct. 22, 2023

(30) Foreign Application Priority Data
Sep. 1, 2023 (TW) 112133363

(51) Int. Cl. B01J 20/22; B01J 20/02; B01J 20/04; B01J 20/08; B01J 20/20; B01J 20/30; C22B 3/42

(52) U.S. Cl. CPC B01J 20/22; B01J 20/0225; B01J 20/04; B01J 20/08; B01J 20/20; B01J 20/3078; C22B 3/42

(57) ABSTRACT

A complex ionic compound includes a carrier, a bridging agent, and an adsorbent. The bridging agent is grafted to the carrier, and the adsorbent is grafted to the bridging agent.

### CROSS-REFERENCE TO RELATED APPLICATION

This application claims the priority benefit of Taiwan application serial no. 112133363, filed on Sep. 1, 2023. The entirety of the above-mentioned patent application is hereby incorporated by reference herein and made a part of this specification.

### BACKGROUND

### Technical Field

The disclosure relates to a complex ionic compound, its preparation method, and its use in recovery of metal ions.

### Description of Related Art

Lithium-ion battery has long been a common power source in our daily life thanks to its high energy density and ease of manufacturing. Currently, positive electrode materials for lithium-ion battery include metal-containing materials, such as lithium cobalt, lithium nickel, lithium nickel cobalt, lithium nickel cobalt manganese. Since metals (e.g., manganese, cobalt, nickel, and lithium) adopted in the positive electrode materials originate from depletable natural resources and such metals in wasted batteries may endanger the environment, how to recover the metals in wasted batteries is one of the critical issues in environment and sustainable development.

### SUMMARY

The disclosure provides a complex ionic compound that facilitates recovery of metal ions.

The disclosure provides a preparation method of a complex ionic compound for facilitating recovery of metal ions.

The disclosure provides a use of a complex ionic compound for recovery of metal ions, capable of simplifying the recovery process of metal ions and reducing the recovery cost of metal ions.

The complex ionic compound of the disclosure includes a carrier, a bridging agent grafted to the carrier, and an adsorbent grafted to the bridging agent.

The carrier of an embodiment of this disclosure includes a C:Na—Ni/Al₂O₃ composite powder.

In an embodiment of the disclosure, the bridging agent includes a halogen-containing siloxane of low molecular weight.

The adsorbent in an embodiment of the disclosure includes at least two of 1-butyl-3-methylimidazolium hexafluorophosphate, 1-ethyl-3-methylimidazolium tetrafluoroborate, 1-ethyl-3-methylimidazolium hexafluorophosphate, 1-butyl-3-methylimidazolium acetate, choline chloride, and glycerol.

The preparation method of a complex ionic compound of the disclosure includes the following steps: grafting a bridging agent to a carrier, and grafting an adsorbent to the bridging agent to form the complex ionic compound.

In an embodiment of the disclosure, the preparation method of the complex ionic compound further includes forming the carrier. Forming the carrier includes: placing a Na—Ni/Al₂O₃ powder in a reactor; and feeding carbon dioxide and hydrogen into the reactor, temperature inside the reactor being from 400° C. to 800° C. to reduce the carbon dioxide into carbon and to enable the carbon to be adsorbed on a Ni atom in the Na—Ni/Al₂O₃ powder to form a C:Na—Ni/Al₂O₃ composite powder.

In an embodiment of the disclosure, the bridging agent includes a chlorine-containing siloxane of low carbon number, as represented in Formula (1) below:

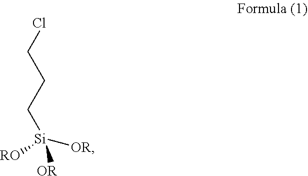

where each R is independently an alkyl of carbon number from 1 to 6.

According to an embodiment of the disclosure, the adsorbent is grafted to a chlorine (Cl) end of the bridging agent.

The adsorbent in an embodiment of the disclosure includes at least two of 1-butyl-3-methylimidazolium hexafluorophosphate, 1-ethyl-3-methylimidazolium tetrafluoroborate, 1-ethyl-3-methylimidazolium hexafluorophosphate, 1-butyl-3-methylimidazolium acetate, choline chloride, and glycerol.

The use of a complex ionic compound in recovery of metal ions of the disclosure includes: adding the complex ionic compound described above to a recovery solution containing metal ions to enable the complex ionic compound to adsorb the metal ions; separating the complex ionic compound that adsorbs the metal ions; performing extraction using a solvent on the complex ionic compound that adsorbs the metal ions to separate the metal ions from the complex ionic compound and to extract the metal ions to the solvent; and purifying the metal ions in the solvent.

In an embodiment of the disclosure, the recovery solution is a lithium-ion battery recovery solution.

According to an embodiment of the disclosure, the metal ions include a manganese (Mn) ion, a cobalt (Co) ion, a nickel (Ni) ion, a lithium (Li) ion or combinations thereof.

In an embodiment of the disclosure, the “separating the complex ionic compound that adsorbs the metal ions” is conducted by using a magnetic material to attract the complex ionic compound.

In an embodiment of the disclosure, the solvent includes ethyl acetate or methanol.

In light of the foregoing, the adsorbent in the complex ionic compound of the disclosure adsorbs the metal ions and thus may be used in separation and extraction of the metal ions to further facilitate recovery of the metal ions. Moreover, the complex ionic compound of the disclosure is magnetic and easy to be extracted. Hence, a recovery method of the metal ions of the disclosure significantly simplifies recovery processes and reduces recovery cost for the metal ions.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic flow chart illustrating a preparation method of a complex ionic compound according to an embodiment of the disclosure.

FIG. 2 indicates decomposition potentials of two different metal ions, metal ion A and metal ion B.

FIG. 3 is a schematic view illustrating a potential-controlling circuit used in electrolytic separation.

### DESCRIPTION OF THE EMBODIMENTS

Embodiments of the disclosure are elaborated on as follows. However, the embodiments are exemplary and do not limit the scope of this disclosure.

In the text herein, a range indicated by “from one numeric value to another numeric value” signifies a general expression for avoiding listing all numeric values one by one in this specification. Hence, description of a certain numeric value range covers any numeric value within the range and any smaller numeric range defined by any numeric value within the range, equivalent of specifying the numeric value and the smaller numeric range.

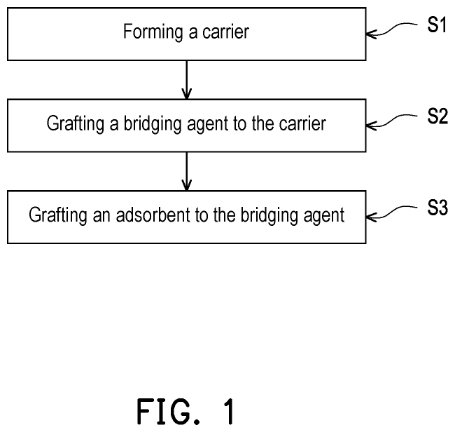

FIG. 1 is a schematic flow chart illustrating a preparation method of a complex ionic compound according to an embodiment of the disclosure.

Please refer to FIG. 1. In the disclosure, the preparation method of a complex ionic compound may include the following steps, yet the disclosure is not limited thereto. First, in step S1, a carrier is formed. Next, in step S2, a bridging agent is grafted to the carrier. In step S3, an adsorbent is grafted to the bridging agent, and this enables the adsorbent to be connected with the carrier through the bridging agent so as to form a complex ionic compound. The steps are elaborated on as follows.

In the disclosure, sequence of grafting the bridging agent and the grafting adsorbent is not specifically limited. In some embodiments, the adsorbent may be grafted to the bridging agent before grafting the bridging agent that is connected to the adsorbent to the carrier through the bridging agent end.

In some embodiments, the carrier may be a C:Na—Ni/Al₂O₃ composite powder. In some embodiments, the C:Na—Ni/Al₂O₃ composite powder may be prepared through fixed bed reactor reduction. For example, forming the C:Na—Ni/Al₂O₃ composite powder may include: placing Na—Ni/Al₂O₃ powder in a reactor, e.g., a fixed bed reactor, and feeding carbon dioxide and hydrogen into the reactor. Temperature in the reactor may be from 400° C. to 800° C., e.g., 500° C., 600° C., or 700° C., so as to reduce the carbon dioxide into carbon (C) and to enable the carbon to be adsorbed on the Na—Ni/Al₂O₃ powder. In some embodiments, carbon-dioxide-to-hydrogen volume ratio is from 3:1 to 1:3. In some embodiments, carbon-dioxide-to-hydrogen volume ratio is 1:1. In some embodiments, duration of feeding carbon dioxide into the reactor is from 2 hours to 36 hours. In some embodiments, the carbon is grafted to the Ni (nickel) atom in the Na—Ni/Al₂O₃ powder to form the C:Na—Ni/Al₂O₃ composite powder.

In some embodiments, forming the C:Na—Ni/Al₂O₃ composite power further includes the following steps: conducting a sintering treatment to rearrange lattice of the C:Na—Ni/Al₂O₃ composite powder. In some embodiments, temperature of the sintering treatment is from 500° C. to 800° C., e.g., 550° C., 650° C., or 750° C. In some embodiments, duration of the sintering treatment is from 1 hour to 2 hours, yet the disclosure is not limited thereto.

The bridging agent may be formed by siloxane of low molecular weight. In some embodiments, the bridging agent may be formed by halogen-containing siloxane of low molecular weight. In some embodiments, the bridging agent may contain chlorine-containing siloxane of low carbon number. For example, the bridging agent may have a structure as represented in Formula (1):

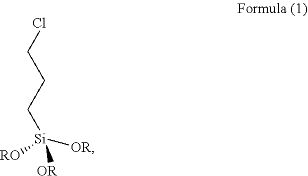

where each R may independently be an alkyl of carbon number from 1 to 6.

The bridging agent may be grafted to the outer surface of carrier by adsorption or bonding. In some embodiments, after the bridging agent is connected to the C:Na—Ni/Al₂O₃ carrier, a structure is formed as represented in Formula (2):

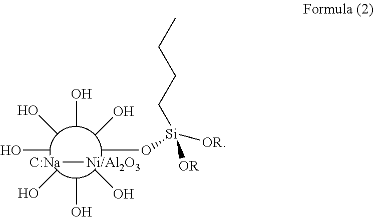

The adsorbent may be derived from deep eutectic solvent (DES). Deep eutectic solvent is commonly deemed as a type of ionic liquid, which may refer to an ionic compound in a liquid state. In some embodiments, the adsorbent is an ionic compound with a positive electric charge. A cation portion that contributes positive electric charge may be an imidazole ion, a pyridine ion, a quaternary phosphonium ion, a quaternary ammonium ion, a guanidinium ion, a sulfonium ion, a choline ion, or a morpholinium ion.

In some embodiments, the adsorbent further includes an anion of higher metal adsorption performance, e.g., a hexafluorophosphate ion (PF₆), a tetrafluoroborate ion (BF₄), a tetrachloroferrate ion (FeCl₄) or acetate ion (OAc). In some embodiments, the adsorbent may include further choline chloride and glycerol. The adsorbent may form stable chelation structure with some metal ions, and thus has high selectivity and ideal adsorption performance and may be used in metal ions detection and separation.

In some embodiments, the adsorbent includes 1-butyl-3-methylimidazolium hexafluorophosphate ([BMIM][PF₆]), 1-ethyl-3-methylimidazolium tetrafluoroborate ([EMIM][B F₄]), 1-ethyl-3-methylimidazoliumhexafluorophosphate ([EMIM][PF₆]), 1-butyl-3-methylimidazolium acetate ([BMIM][OAc]), choline chloride, glycerol, or combinations thereof. In some embodiment, the adsorbent includes at least two of 1-butyl-3-methylimidazolium hexafluorophosphate, 1-ethyl-3-methylimidazolium tetrafluoroborate, 1-ethyl-3-methylimidazolium hexafluorophosphate, 1-butyl-3-methylimidazolium acetate, choline chloride, and glycerol.

The adsorbent may be grafted to the outer surface of carrier by adsorption or bonding. In some embodiment, by grafting the adsorbent on the bridging agent, one end of the bridging agent is connected to the carrier and the other end is connected to the adsorbent, so the adsorbent is grafted to the carrier. In some embodiments, the adsorbent is grafted to the C:Na—Ni/Al₂O₃ carrier through the chlorine end of the bridging agent, and thus a complex ionic compound is formed as represented in Formula (3) below:

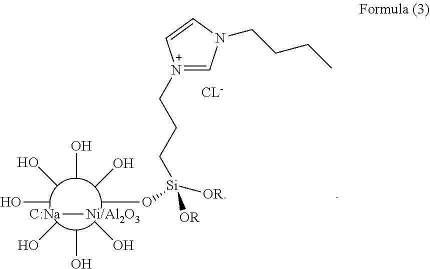

For example, the chlorine-containing siloxane (the bridging agent) as represented in Formula (1) may be reduced in acid environment (pH=4 to 5) and hence the chlorine-containing siloxane has a hydroxy group. The reduced chlorine-containing siloxane subsequently reacts with the C:Na—Ni/Al₂O₃ composite power (carrier) to graft the chlorine-containing siloxane to the C:Na—Ni/Al₂O₃ composite powder through the hydroxy group. Next, in an acid environment (pH=4 to 5), a deep eutectic solvent containing 1-butyl-3-methylimidazolium hexafluorophosphate and 1-ethyl-3-methylimidazolium tetrafluoroborate (adsorbent) is added. The 1-butyl-3-methylimidazolium hexafluorophosphate and the 1-ethyl-3-methylimidazolium tetrafluoroborate react with a chlorine group of the chlorine-containing siloxane. Thus, each of the 1-butyl-3-methylimidazolium hexafluorophosphate and the 1-ethyl-3-methylimidazolium tetrafluoroborate is grafted to the chlorine-containing siloxane. Consequently, each of the 1-butyl-3-methylimidazolium hexafluorophosphate and the 1-ethyl-3-methylimidazolium tetrafluoroborate is capable of being grafted to the carrier through the bridging agent. The complex ionic compound of the disclosure is therefore prepared. Alternatively, by having 1-butyl-3-methylimidazolium hexafluorophosphate and the 1-ethyl-3-methylimidazolium tetrafluoroborate reacted with the chlorine-containing siloxane to form an intermediate before having the intermediate reacted with the C:Na—Ni/Al₂O₃ composite powder, each of the 1-butyl-3-methylimidazolium hexafluorophosphate and the 1-ethyl-3-methylimidazolium tetrafluoroborate may also be grafted to the C:Na—Ni/Al₂O₃ composite powder through the chlorine-containing siloxane.

In some embodiments, complex ionic compound includes: the carrier, the bridging agent grafted to the carrier, and two types of adsorbents that are individually grafted to the bridging agent. In some embodiments, under different reaction conditions, two or more types of adsorbents are individually grafted to the carrier, and different adsorbents may come with different reactions, such as adsorption reaction or depolymerization reaction. In some embodiments, the weight ratio of the adsorbent to the carrier in the complex ionic compound is greater than or equal to 1.8 and is less than or equal to 3.

The complex ionic compound of the disclosure may be used in the recovery of metal ions, e.g., in the recovery of metal ions in lithium-ion battery recovery solution. In some embodiments, the recovery method of the metal ions may include the following steps. Firstly, the complex ionic compound may be added to the lithium-ion battery recovery solution to enable the complex ionic compound to adsorb the metal ions in the lithium-ion battery recovery solution, e.g., the manganese ions, the cobalt ions, the nickel ions, the lithium ions or combinations thereof. Next, since the complex ionic compound is magnetic, a magnetic material (e.g., a magnet) may be used to attract the complex ionic compound that adsorbs the metal ions, and hence the complex ionic compound that adsorbs the metal ions is adhered to the magnetic material. Lastly, the complex ionic compound that adsorbs the metal ions may be separated through filtering. Thus, the separation process of the complex ionic compound is significantly simplified.

In some embodiments, by using a solvent, the metal ions adsorbed by the complex ionic compound may further be washed off, and the complex ionic compound with the metal ions removed may be reused. In some embodiments, each type of the metal ions that have been washed off may be individually separated and purified through electrochemical technology. For example, the metal ions adsorbed by the complex ionic compound may be extracted through solvent extraction. In some embodiments, a volatile organic solvent (e.g., ethyl acetate and methanol) may be used to perform solvent extraction on the complex ionic compound that adsorbs the metal ions so as to separate the metals ions from the complex ionic compound and to extract the metal ions to the organic solvent. Subsequently, the metal ions in the solvent may be separated and purified through evaporation of the volatile solvent or by other suitable methods.

In some embodiments, the metal ions in the organic solvent may be separated and purified through electrolysis reduction. For example, the metal ions in the organic solvent may undergo electrolysis reduction as electrolytes. At suitable potential and under suitable electrolysis conditions, the metal ions may be reduced to metal and purified metal may be collected from electrolysis electrodes.

In some embodiments, the metal ions in the organic solvent may be separated and purified through the electrochemical separation method (potential-controlling electrolysis separation) described below.

As two or more than two types of metal ions exist in the solution and a reduction potential of one of the metal ions is close to that of another metal ion, e.g., Cu²⁺ (standard electrode potential E°=+0.345 volt) and Bi³⁺ (E°=+0.2 volt), both of the metal ions are reduced and separated. Thus, separation purpose is not fulfilled.

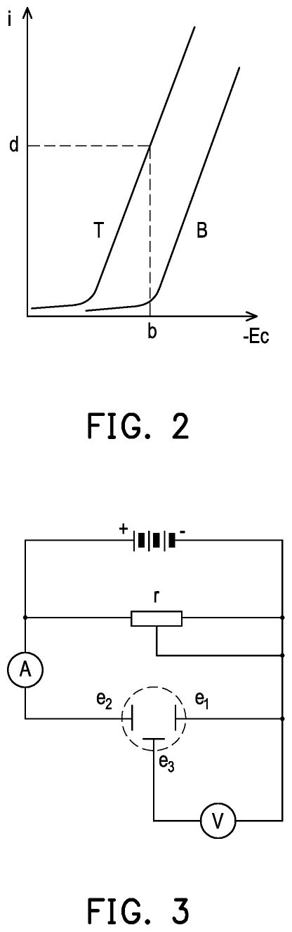

FIG. 2 illustrates electrolysis potentials of two different types of metal ions, metal ion T and metal ion B. Please refer to FIG. 2. If cathode potential is controlled to be potential b, the metal ion T generates a current of current intensity d and the metal ion T is therefore reduced. However, the metal ion B has extremely low current intensity and is hardly reduced. Consequently, the separation purpose is fulfilled while the metal ion T and the metal ion B are separately measured.

In some embodiments, a reducing electrode is the cathode. To control a cathode potential, applied voltage needs to be adjusted at all times. Electrode materials are corrosion-resistant and highly reactive materials. Generally, platinum group metals are adopted. FIG. 3 is a schematic view illustrating a potential-controlling circuit used in electrolytic separation. In FIG. 3, an electrode e1 is a platinum gauze cathode, an electrode e2 is a platinum wire counter electrode, and an electrode e3 is a reference electrode (e.g., saturated calomel electrode). A potential of the chosen electrode e1 (with respect to the electrode e3) may be read on a potentiometer V. An electrolysis current is read on a millimeter A. During the electrolysis, resistance r is constantly adjusted to remain the same cathode potential.

In some embodiments, the plurality of types of metal ions adsorbed by the complex ionic compound may be separated through techniques of selective electrochemical separation of metals. For example, for the complex ionic compound that adsorbs a plurality of types of metal ions, the metal ions may first be dissolved using sulfuric acid or hydrochloric acid. Subsequently, according to differences in redox potential among each type of the plurality of metal ions, each type of the plurality of metals is selectively reduced in succession through voltage controlling so as to fulfill metal separation purpose. For example, each of the following formulas indicates a redox potential of nickel (Ni), manganese (Mn), cobalt (Co), or lithium (Li) for separating Ni, Mn, Co, and Li.

$${Ni}^{+ 2} + 2 {e}^{-} ↔ Ni {E}^{0} = - 0 \text{.25} V$$

$${Co}^{+ 2} + 2 {e}^{-} ↔ Co {E}^{0} = - 0 \text{.28} V$$

$${Mn}^{+ 2} + 2 {e}^{-} ↔ Mn {E}^{0} = - 1 \text{.199} V$$

$${Li}^{+} + {e}^{-} ↔ Li {E}^{0} = - 3.04 V$$

Separation of the metals may be conducted in the following steps.

In some embodiments, voltage (E°) is controlled to be from −0.3V to −1.2V, and thus the metals Ni and Co are deposited on the electrode surface.

In some embodiments, voltage (E°) is controlled to be from −1.2V to −3V, and thus the metal Mn is deposited on the electrode surface.

In some embodiments, voltage (E°) is controlled to be >−3V, and thus the metal Li is deposited on the electrode surface.

Hence, by adjusting to different voltage (E°) intervals, metal separation is achieved.

In light of the foregoing, since the adsorbent in the complex ionic compound of the disclosure interacts with the metal ions and results in chelation coordination, the adsorbent may be used in separation and extraction of the metal ions to further facilitate recovery of the metal ions. Moreover, since the complex ionic compound is magnetic and therefore easy to be separated, the recovery method of the metal ions of the disclosure significantly simplifies recovery process and reduces recovery cost for the metal ions.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A complex ionic compound, comprising:
a carrier
a bridging agent, grafted to the carrier; and
an adsorbent, grafted to the bridging agent.

2. The complex ionic compound according to claim 1, wherein the carrier comprises a C:Na—Ni/Al₂O₃ composite powder.

3. The complex ionic compound according to claim 1, wherein the bridging agent comprises a halogen-containing siloxane of low molecular weight.

4. The complex ionic compound according to claim 1, wherein the adsorbent comprises at least two of 1-butyl-3-methylimidazolium hexafluorophosphate, 1-ethyl-3-methylimidazolium tetrafluoroborate, 1-ethyl-3-methylimidazolium hexafluorophosphate, 1-butyl-3-methylimidazolium acetate, choline chloride, and glycerol.

5. A preparation method of a complex ionic compound, comprising:
grafting a bridging agent to a carrier; and
grafting an adsorbent to the bridging agent to form the complex ionic compound.

6. The preparation method of the complex ionic compound according to claim 5, further comprising:
forming the carrier, wherein forming the carrier comprises:
placing a Na—Ni/Al₂O₃ powder in a reactor; and
feeding carbon dioxide and hydrogen into the reactor, wherein temperature inside the reactor is from 400° C. to 800° C. to reduce the carbon dioxide into carbon and to enable the carbon to be adsorbed on a Ni atom in the Na—Ni/Al₂O₃ powder to form a C:Na—Ni/Al₂O₃ composite powder.

7. The preparation method of the complex ionic compound according to claim 5, wherein the bridging agent comprises a chlorine-containing siloxane of low carbon number as represented in Formula (1) below: 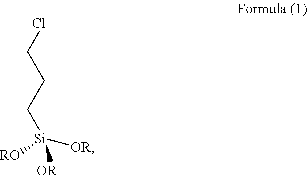
wherein each R is independently an alkyl of carbon number from 1 to 6.

8. The preparation method of the complex ionic compound according to claim 7, wherein the adsorbent is grafted to a chlorine end of the bridging agent.

9. The preparation method of the complex ionic compound according to claim 5, wherein the adsorbent comprises at least two of 1-butyl-3-methylimidazolium hexafluorophosphate, 1-ethyl-3-methylimidazolium tetrafluoroborate, 1-ethyl-3-methylimidazolium hexafluorophosphate, 1-butyl-3-methylimidazolium acetate, choline chloride, and glycerol.

10. A use of a complex ionic compound in recovery of metal ions, comprising:
adding the complex ionic compound according to claim 1 to a recovery solution that contains metal ions to enable the complex ionic compound to adsorb the metal ions;
separating the complex ionic compound that adsorbs the metal ions;
performing extraction using a solvent on the complex ionic compound that adsorbs the metal ions to separate the metal ions from the complex ionic compound and to extract the metal ions to the solvent; and
purifying the metal ions in the solvent.

11. The use according to claim 10, wherein the recovery solution is a lithium-ion battery recovery solution.

12. The use according to claim 10, wherein the metal ions comprise a manganese ion, a cobalt ion, a nickel ion, a lithium ion or combinations thereof.

13. The use according to claim 10, wherein separating the complex ionic compound that adsorbs the metal ions is conducted by using a magnetic material to attract the complex ionic compound.

14. The use according to claim 10, wherein the solvent comprises ethyl acetate or methanol.
